(19) United States
(12) Patent Application Publication
(10) Pub. No.: US 2009/0109701 A1
(43) Pub. Date: Apr. 30, 2009

(54) ILLUMINANT BUSINESS CARD

(75) Inventors: SHU-HUI HSIEH, Chu-Nan (TW); TSE-AN LEE, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/139,082

(22) Filed: Jun. 13, 2008

(30) Foreign Application Priority Data
Oct. 31, 2007 (CN) 200710202332.8

(51) Int. Cl. F21V 7/04

(52) U.S. Cl. 362/604

(57) ABSTRACT

An illuminant business card includes a light guiding card body, at least a light emitting diode and a power source. The light guiding card body includes a front surface with display information arranged thereon, a rear surface opposite to the front surface, and a plurality of side surfaces interconnecting the front and rear surfaces. The at least a light emitting diode couples to the light guiding card body optically. The power source is electrically connected to the at least a light emitting diode to supply an electric current to the at least a light emitting diode to illuminate the display information of the light guiding card body.

### BACKGROUND

1. Field of the Invention

The present invention relates to a business card, and particularly to a business card incorporating a lighting element.

2. Description of Related Art

Business cards are widely used as identifiers of the presenter and as a token of agency. They are usually presented to customers when a first contact is initiated, and exchanged between colleagues among business meetings, conventions, or social events.

A business card is typically associated with a single individual. The name of the individual, the name of the company/business which the individual represents, a brief description of the company/business, and contact information are generally printed on the business card. However, a problem associated with typical business cards is that the business card is usually made of paper, which does not have the abilities to generate light therefrom. Thus, the business card cannot be recognized in a dark circumstance.

For the foregoing reasons, therefore, there is a need in the art for a new business card to overcome the above-mentioned problems.

### SUMMARY

An exemplary illuminant business card includes a light guiding card body, at least a light emitting diode and a power source. The light guiding card body includes a front surface with display information arranged thereon, a rear surface opposite to the front surface, and a plurality of side surfaces interconnecting the front and rear surfaces. The at least a light emitting diode optically couples to the light guiding card body. The power source is electrically connected to the at least a light emitting diode to supply an electric current to the at least a light emitting diode to illuminate the display information of the light guiding card body.

Other advantages and novel features of the present invention will become more apparent from the following detailed description of embodiments when taken in conjunction with the accompanying drawings.

### BRIEF DESCRIPTION OF THE DRAWINGS

FIG. 1 is an isometric, assembled view of an illuminant business card in accordance with an exemplary embodiment;

FIG. 2 is an explored view of the illuminant business card of FIG. 1;

FIG. 3 is an isometric view of the illuminant business card according to a second embodiment; and

FIG. 4 is shows a third embodiment of the illuminant business card.

### DETAILED DESCRIPTION

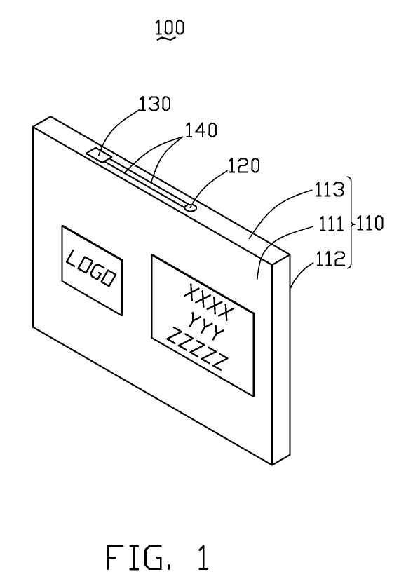

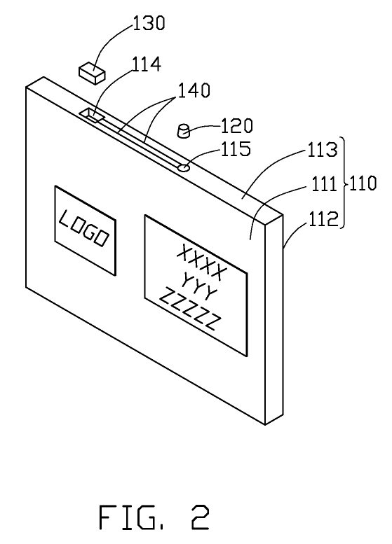

Referring to FIGS. 1-2, an illuminant business card 100 in accordance with an exemplary embodiment includes a light guiding card body 110, a light emitting diode (LED) 120, and a power source 130.

The light guiding card body 110 is made of transparent and rigid material, such as polycarbonate (PC), polymethyl methacrylate (PMMA), polyvinyl chloride (PVC), resin, glass, quartz, silicone, epoxy etc. The light guiding card body 110 has an elongated rectangle shape and includes a front surface 111, a rear surface 112, and four side surfaces 113 interconnecting the front and rear surfaces 111, 112. Display information of an individual, such as the name, the name of the company/business which the individual represents, a brief description of the company/business, and contact information are generally arranged on the front surface 111 of the light guiding card body 110. Alternatively, the display information can be arranged on both of the front and rear surfaces 111, 112 of the light guiding card body 110 allowing more information to be arranged on the business card 100.

The LED 120 optically couples to the light guiding card body 110. In this embodiment, the light guiding card body 110 defines a slot 115 in a top side surface 113 thereof. The LED 120 is received in the slot 115. The power source 130 is configured for supplying an electric current to the LED 120. A groove 114 is defined in the top side surface 113 of the light guiding card body 110 and is configured for receiving the power source 130 therein. In this embodiment, the power source 130 is a thin battery. Preferably, a detector is connected to the battery to absorb radio wave or electromagnetic wave for charging the battery. The LED 120 and the power source 130 are spaced from each other. A printed circuit board (PCB) 140 is formed on the top side surface 113 of the light guiding card body 110. The PCB 140 is located between and interconnects the LED 120 and the power source 130. Alternatively, a flexible printed circuit board (FPCB) can be adhered to the top side surface 113 of the light guiding card body 110 and electrically connects the LED 120 with the power source 130. A switch (not shown) can be connected to the LED 120 for turning on/off the electric current of the power source 130 supplied to the LED 120.

As the business card 100 incorporating the LED 120, the business card 100 can be illuminated when being used in a dark circumstance by supplying the electric current from the power source 130 to the LED 120. The light emitted by the LED 120 travels through the light guiding card body 110 of the business card 100 which optically couples to the LED 120 to illuminate the display information arranged on the front surface 111 or rear surface 112 of the light guiding card body 110. When the business card 100 is used in a bright circumstance, the LED 120 can be turned off by the switch.

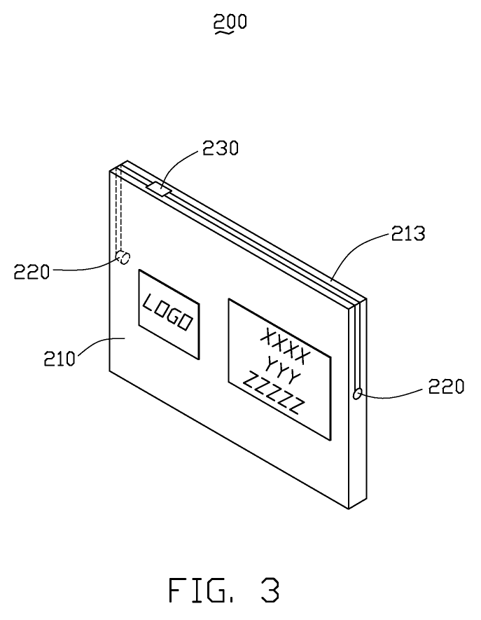

FIG. 3 shows an alternative embodiment of the illuminant business card 200. The difference between this embodiment and the first embodiment is that the business card 200 has a pair of LEDs 220 optically coupling to the light guiding card body 210. The two LEDs 220 are mounted on two opposite side surfaces 213 of the light guiding card body 210, respectively. Similar to the first embodiment, the power source 230 is arranged in the top side surface 213 of the light guiding card body 220. The LEDs 220 are mounted at left and right side surfaces 213 of the light guiding card body 210. The left and right side surfaces 213 each define a slot (not shown) receiving the LED 220 therein.

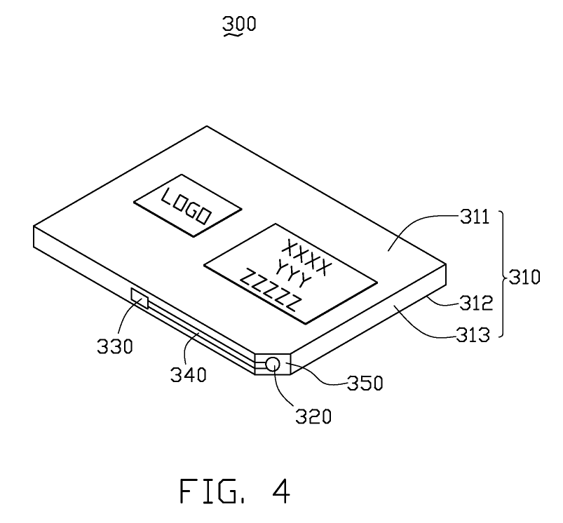

FIG. 4 shows a third embodiment of the illuminant business card 300. Similar to the first embodiment, the business card 300 includes a light guiding card body 310, an LED 320, and a power source 330. The light guiding card body 310 has an elongated rectangle shape, and includes a front surface 311, a rear surface 312 and four side surfaces 313. The four side surfaces 313 are connected with each other. Two adjacent side surfaces 313 intersect to form a corner 350 of the light guiding card body 310. One of the four side surfaces 313 obliquely adjoining an adjacent side surface 313 with the LED 320 being optically coupled thereto. An aslant surface is thus formed at the corner 350 and interconnects the two adjacent side surfaces 313. The LED 320 is mounted on the aslant surface, and the power source 330 is mounted on one of the two adjacent surfaces 313. The LED 320 and the power source 330 are electrically connected through the circuit board 340. As an angle between the two adjacent side surfaces 313 is 90 degree, the LED 320 arranged at the corner 350 of the light guiding card body 310 can illuminate whole front surface 311 and rear surface 312 of the light guiding card body 310. Thus all of the display information arranged on the business card 300 can be recognized even in a dark circumstance.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illuminant business card comprising:
a light guiding card body having a front surface with display information arranged thereon, a rear surface opposite to the front surface, and a plurality of side surfaces interconnecting the front and rear surfaces;
at least a light emitting diode optically coupled to the light guiding card body; and
a power source electrically connected to the at least a light emitting diode to supply an electric current to the at least a light emitting diode.

2. The illuminant business card of claim 1, wherein the light guiding card body is comprised of a transparent and rigid material.

3. The illuminant business card of claim 2, wherein the light guiding card body is comprised of a material selected from the group consisting of polycarbonate, polymethyl methacrylate, polyvinyl chloride, resin, glass, quartz, silicone, and epoxy.

4. The illuminant business card of claim 1, wherein the power source includes a thin battery.

5. The illuminant business card of claim 4, further comprising a detector connected to the battery to absorb radio wave or electromagnetic wave for charging the battery.

6. The illuminant business card of claim 1, wherein a printed circuit board is arranged on the light guiding card body for electrically interconnecting the power source and the at least a light emitting diode.

7. The illuminant business card of claim 6, wherein the printed circuit board is a flexible printed circuit board, and the flexible printed circuit board is adhered to the light guiding card body.

8. The illuminant business card of claim 1, wherein a slot is defined in one of the side surfaces of the light guiding card body receiving the at least a light emitting diode therein.

9. The illuminant business card of claim 1, wherein a groove is defined in one of the side surfaces of the light guiding card body receiving the power source therein.

10. The illuminant business card of claim 1, wherein the at least a light emitting diode comprises two light emitting diodes arranged at opposite side surfaces of the light guiding card body.

11. The illuminant business card of claim 1, wherein the light guiding card body is substantially elongated rectangle shaped, one of the side surfaces obliquely adjoining adjacent side surface with the at least a light emitting diode being optically coupled thereto.

12. An illuminant business card comprising:
at least a light emitting diode for emitting light;
a light guiding card body optically coupled to the at least a light emitting diode, the light guiding card body having a front surface with display information arranged thereon, a rear surface opposite to the front surface, and a plurality of side surfaces interconnecting the front and rear surfaces, a slot being defined in the side surfaces receiving the at least a light emitting diode therein; and
a power source electrically connected to the at least a light emitting diode to supply an electrical current to the at least a light emitting diode to illuminate the display information of the light guiding card body.

13. The illuminant business card of claim 12, wherein a groove is defined in the side surfaces receiving the power source therein.

14. The illuminant business card of claim 12, wherein the at least a light emitting diode comprises two light emitting diodes arranged at opposite side surfaces of the light guiding card body.

15. The illuminant business card of claim 12, wherein the light guiding card body is substantially elongated rectangle shaped, one of the side surfaces obliquely adjoining adjacent side surface with the at least a light emitting diode being optically coupled thereto.
